(19) United States
(12) Patent Application Publication
(10) Pub. No.: US 2026/0281598 A1
(43) Pub. Date: Sep. 17, 2026

(54) ELECTRONIC DEVICE AND METHOD FOR RECEIVING VOICE OF USER

(71) Applicant: UPBEAT TECHNOLOGY Co., Ltd, New Taipei City (TW)

(72) Inventors: Da-Lun YUAN, New Taipei City (TW); Chih Hsuan HUANG, New Taipei City (TW); Meng-Ting TSAI, New Taipei City (TW)

(21) Appl. No.: 19/565,611

(22) Filed: Mar. 13, 2026

Related U.S. Application Data
(60) Provisional application No. 63/771,082, filed on Mar. 13, 2025.

(30) Foreign Application Priority Data
Nov. 7, 2025 (TW) 114143487

(51) Int. Cl. H04R 1/08; H04R 1/04

(52) U.S. Cl. CPC H04R 1/08; H04R 1/04; H04R 2201/003; H04R 2420/07

(57) ABSTRACT

An electronic device for sensing the voice of a user is provided by an aspect of the present disclosure. The electronic device includes a bone-conduction microphone (BCM) chip configured for sensing a vibration caused by the voice in a first direction and converting the vibration into an audio signal. The electronic device also includes a vibration plate. The BCM chip is fixed on a first surface of the vibration plate. The first surface is perpendicular to the first direction. The electronic device also includes a bracket. The vibration plate is flexibly disposed on one end of the bracket.

This application claims the benefit of U.S. provisional application Ser. No. 63/771,082, filed Mar. 13, 2025, and Taiwan application Serial No. 114143487, filed Nov. 7, 2025, the subject matter of which are incorporated herein by reference.

### TECHNICAL FIELD

The disclosure relates in general to an electronic device, and more particularly, to electronic devices with bone-conduction vibration sensor.

### BACKGROUND

Microphone chips implemented using microelectromechanical systems (MEMS) technique, such as bone-conduction microphone (BCM) chips or bone-conduction vibration sensors, are configured to directly sense the vibrations of the vocal cords through the skin or bone to a sensing element therein to convert the voice of a user into electrical signals. While this method can effectively isolate the voice of the user from environmental noise, it requires a contact-wear configuration that is maintained in close contact with the user's skin. In certain usage scenarios, the contact-wear design may cause discomfort or inconvenience to the user. Therefore, there are needs for technique using bone-conduction microphone chips that can sense a user's voice without requiring direct contact with the user's skin or bone.

### SUMMARY

According to implementations of the present disclosure, an electronic device with a non-contact bone-conduction microphone (BCM) chip is provided. In some implementations, the electronic device is configured as a non-contact device using a MEMS bone-conduction microphone (BCM) chip, and its structural design enables it to sense the voice of a user and convert it into an audio signal without directly contacting the skin or bones of the user.

The first aspect of the present disclosure features an electronic device for sensing voice of a user. The electronic device includes a bone-conduction microphone (BCM) chip configured to sense vibrations caused by a voice in a first direction and to convert the vibrations into an audio signal. The electronic device also includes a vibration plate. The bone-conduction microphone chip is fixed on a first surface of the vibration plate, and the first surface is perpendicular to the first direction. The electronic device also includes a bracket. The vibration plate is flexibly disposed on one end of the bracket.

The second aspect of the present disclosure features a method for receiving a voice of a user, executed by the electronic device of the first aspect of the present disclosure. The method includes steps of: (a) securely mounting the vibration plate on the bracket of the electronic device; (b) positioning a surface of the vibration plate substantially perpendicular to a direction of sound emission of an user; (c) causing the vibration plate to vibrate by a sound wave generated by the voice of the user; and (d) detecting a vibration signal of the vibration plate and converting the vibration into an electronic signal representing the voice of the user.

The details of one or more disclosed implementations are set forth in the accompanying drawings and the description below. Other features, aspects, and advantages will become apparent from the description, the drawings, and the claims.

### BRIEF DESCRIPTION OF THE DRAWINGS

FIG. 1 is a structural diagram illustrating an electronic device including a BCM chip, according to some implementations of the present disclosure.

FIG. 2A is a block diagram illustrating an example electronic device, according to some implementations of the present disclosure.

FIG. 2B is a block diagram illustrating another example of electronic device, according to some implementations of the present disclosure.

FIG. 2C is a block diagram illustrating yet another example electronic device, according to some implementations of the present disclosure.

FIG. 3A is a diagram illustrating an example use scenario of an electronic device, according to some implementations of the present disclosure.

FIG. 3B is a diagram illustrating another example of use scenario of an electronic device, according to some implementations of the present disclosure.

FIG. 4 is a flowchart illustrating a procedure for receiving voice of a user for an electronic device, according to some implementations of the present disclosure.

In the following detailed description, for purposes of explanation, numerous specific details are set forth to provide a thorough understanding of the disclosed embodiments. It will be apparent, however, that one or more embodiments may be practiced without these specific details. In other instances, well-known structures and devices are schematically shown to simplify the drawing.

### DETAILED DESCRIPTION

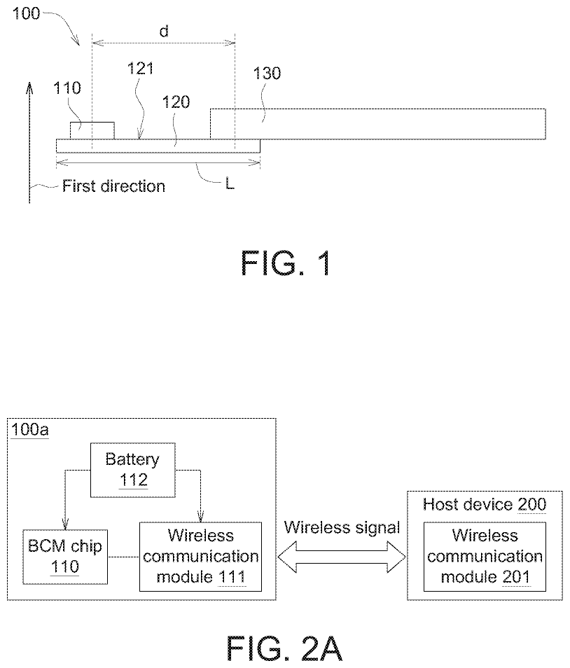

FIG. 1 is a structural diagram illustrating an electronic device 100 including a BCM chip 110, according to some implementations of the present disclosure. The electronic device 100 is mainly a rod-shaped suspension structure. The electronic device 100 includes a BCM chip 110, a vibration plate 120, and a bracket 130. The BCM chip 110 is fixed to the vibration plate 120, and the vibration plate 120 is flexibly disposed on one end of the bracket 130. In some implementations, the vibration plate 120 may be a lightweight plastic sheet with a thickness not exceeding 0.3 mm, a length L of 2.5 cm, and a width of 1.5 cm to form a surface area of 3.75 cm². In some implementations, the vibration plate 120 may be flexibly disposed on one end of the bracket 130 via at least one screw. In some other implementations, the vibration plate 120 may be flexibly disposed on one end of the bracket 130 via a tail sleeve. In yet some other implementations, the vibration plate 120 can be flexibly disposed on one end of the bracket 130 via a latch structure. Considering the torque relationship, the position of the BCM chip 110 on the vibration plate 120 should be located away from the mounting point of the vibration plate 120 on the bracket 130. That is, the greater the distance d between the position of the BCM chip 110 on the vibration plate 120 and the mounting point of the vibration plate 120 on the bracket 130, the better. The distance d can be more than 50% of the length L of the vibration plate 120. For example, when the length L of the vibration plate is 2.5 cm, the distance d between the position of the chip 110 on the vibration plate 120 and the mounting point of the vibration plate 120 on the bracket 130 is at least 1.25 cm. In yet some other implementations, the vibration plate 120 can be supported by a sponge (or polyurethane, not shown) disposed between the vibration plate 120 and the bracket 130, such that the vibration plate 120 is flexibly disposed on one end of the bracket 130. The contact area between the sponge and the vibration plate 120 can be approximately equal to the area of the vibration plate 120, and the vibration plate 120 and the sponge can be fixed by double-sided tape. The BCM chip 110 using MEMS technique is firmly attached to the first surface 121 of the vibration plate 120. The BCM chip 110 is used to sense vibrations caused by sound in the first direction and convert the vibrations into audio signals, wherein the first direction is the direction in which the voice is transmitted. In some implementations, the first surface 121 of the vibration plate 120 is perpendicular to the first direction and faces away from the direction of sound transmission, as shown in FIG. 1. In some other examples, the first surface 121 of the vibration plate 120 may face the direction of sound transmission (the first direction), so that the BCM chip 110 disposed on the first surface 121 also faces the direction of sound transmission (the first direction).

Through the suspension structure configuration of the electronic device 100 provided according to some implementations of the present disclosure, the vibration plate 120 can be positioned in front of the user's mouth. Accordingly, when the user speaks, creates sound waves propagate through the air, impacting and causing the vibration plate 120 to vibrate slightly in the first direction. The vibration energy is then directly transmitted through the solid medium (i.e., the vibration plate 120) to the BCM chip 110 disposed on the first surface 121 of the vibration plate 120, such that the BCM chip 110 senses the vibration and converts it into a corresponding electronic signal (audio signal) to sample the user's voice.

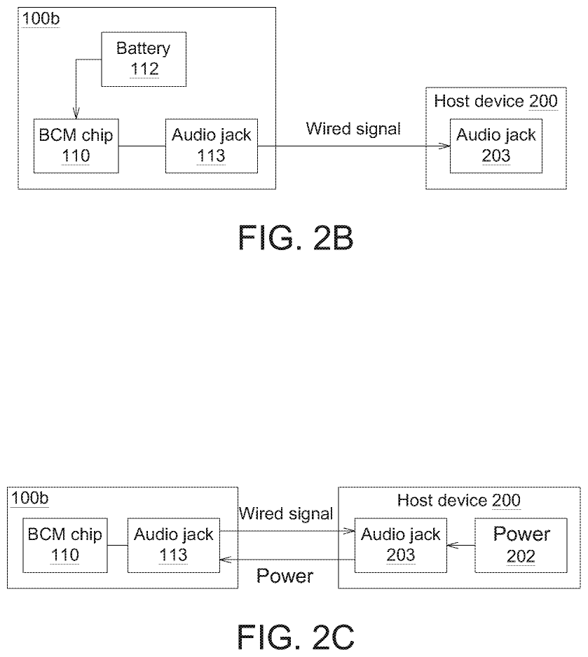

FIG. 2A is a block diagram illustrating an example of electronic device 100a, according to some implementations of the present disclosure. Based on the structure of the electronic device 100 in FIG. 1 described above, the electronic device 100a includes a BCM chip 110, a wireless communication module 111, and a battery 112. The wireless communication module 111 is coupled to the BCM chip 110 and is used to transmit an audio signal generated by the BCM chip 110 to the wireless module 201 of the host device 200, so that the host device 200 receives the audio signal generated by the BCM chip 110. The battery 112 is coupled to the wireless communication module 111 and the BCM chip, 110. Battery 112 is used to supply power to the wireless communication module 111 and the BCM chip 110.

FIG. 2B is a block diagram illustrating another example of electronic device 100b, according to some implementations of the present disclosure. Also, based on the structure of the electronic device 100 in FIG. 1 described above, the electronic device 100b includes a BCM chip 110, a battery 112, and an audio jack 113. The audio jack 113 is coupled to the BCM chip 110 and is configured to transmit the audio signal generated by the BCM chip 110 to the audio jack 203 of the host device 200 via a wired connection (e.g., an audio cable), so that the host device 200 can receive the audio signal generated by the BCM chip 110. The battery 112 is coupled to the BCM chip 110 and is used to supply power to the BCM chip 110. The audio jack 113 and the battery 112 can be disposed on the bracket 130 in FIG. 1. In this example, the bracket 130 may have a hollow metal tube (not shown in the figure), and the audio jack 113 and the battery 112 can be coupled to the BCM chip 110 disposed on the first surface 121 of the vibration plate 120 via wires passing through the hollow metal tube of the bracket 130.

FIG. 2C is a block diagram illustrating yet another example of electronic device 100c, according to some implementations of the present disclosure. Also, based on the structure of the electronic device 100 in FIG. 1 described above, the electronic device 100c includes a BCM chip 110 and an audio jack 113. The audio jack 113 is coupled to the BCM chip 110 and is configured to transmit the audio signal generated by the BCM chip 110 to the audio jack 203 of the host device 200 via a wired connection (e.g. an audio cable), so that the host device 200 receives the audio signal generated by the BCM chip 110 and receives power 202 from the host device 200. The audio jack 113 may be disposed on the bracket 130 in FIG. 1. In this example, the bracket 130 may have a hollow metal tube (not shown in the figure), and the audio jack 113 may be coupled to the BCM chip 110 disposed on the first surface 121 of the vibration plate 120 through a wire passing through the hollow metal tube of the bracket 130.

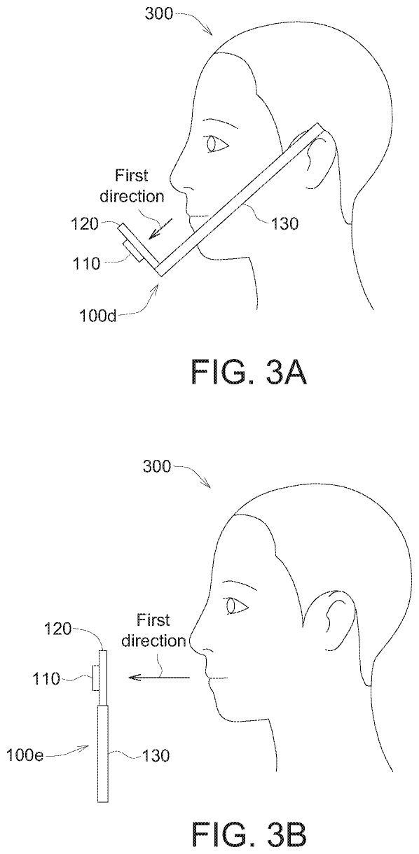

FIG. 3A is a diagram illustrating an example of an electronic device 100d, according to some implementations of the present disclosure. As shown in FIG. 3A, the electronic device 100d can be fixed to the head of the user 300 via the bracket 130, and the vibration plate 120 is positioned in front of the user's mouth. Accordingly, when the user speaks, the sound waves propagate through the air, impacting and causing the vibration plate 120 to vibrate slightly in the first direction. The vibration is then sensed by the BCM chip 110 and converted into corresponding electrical signals (audio signals) to sample the user's voice.

FIG. 3B is a diagram illustrating another example of an electronic device 100e, according to some implementations of the present disclosure. As shown in FIG. 3B, the electronic device 100e can be fixed to other places, such as a desktop, via the bracket 130. Similarly, the vibration plate 120 is positioned in front of the user's mouth. Accordingly, when the user speaks, the sound waves propagate through the air and impact the vibration plate 120 in the first direction, causing it to vibrate slightly. The BCM chip 110 then senses the vibration and converts it into corresponding electrical signals (audio signal) to sample the user's voice.

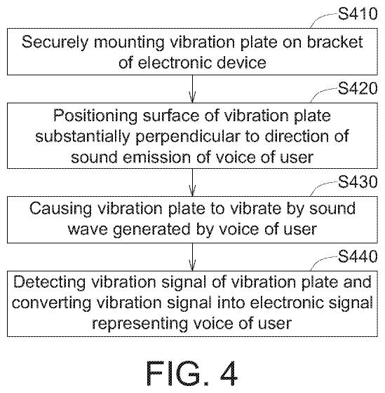

FIG. 4 is a flowchart illustrating a procedure for receiving voice of a user by an electronic device, according to some implementations of the present disclosure. In step S410, the vibration plate 120 of the electronic device 100, for example, in FIG. 1, is securely mounted on the bracket 130 of the electronic device 100 to reduce interference from environmental vibrations other than the sound waves generated by the user. In step S420, the electronic device 100 is configured such that the surface of the vibration plate 120 is approximately perpendicular to the direction of the voice of the user, thereby improving sound wave transmission efficiency. In step S430, the electronic device 100 causes the vibration plate 120 to vibrate due to the sound waves generated by the user. In step S440, the BCM chip 110 in FIG. 1, for example, detects the vibration signal of the vibration plate 120 and converts the vibration signal into electrical signals representing the voice of the user.

The structure of the vibration plate and BCM chip provided according to implementations of the present disclosure enables the sound reception path mediated by solid vibration. Through the solid coupling interface established by the vibration plate, detailed characteristics of the voice can be preserved while reducing the probability of environmental noise interference. Additionally, the non-contact configuration avoids the need for close contact between the bone-conduction device and the user's skin, reducing the risk of user discomfort or damage to conventional bone-conductions device due to prolonged wear. This enhances the overall comfort and flexibility of the electronic device disclosed herein in wearable applications, and can be implemented as, for example, a headband microphone, a boom microphone, a helmet-mounted walkie-talkie, or other similar sound sensing devices.

It will be apparent to those skilled in the art that various modifications and variations can be made to disclose embodiments. It is intended that the specification and examples be considered exemplary only, with a true scope of the disclosure being indicated by the following claims and their equivalents.

What is claimed is:

1. An electronic device, for sensing voice of a user, comprising:
a bone-conduction microphone (BCM) chip, configured to sense a vibration caused by a voice in a first direction and to convert the vibration into audio signals;
a vibration plate, wherein the bone-conduction microphone chip is fixed on a first surface of the vibration plate, and the first surface is perpendicular to the first direction; and
a bracket, wherein the vibration plate is flexibly disposed on one end of the bracket.

2. The electronic device of claim 1, wherein a thickness of the vibration plate is less than 0.3 mm, a length of the vibration plate is 2.5 cm, a width of the vibration plate is 1.5 cm, and a surface area of the vibration plate is 3.75 cm².

3. The electronic device of claim 1, wherein the vibration plate is flexibly disposed on one end of the bracket via at least one screw.

4. The electronic device of claim 1, wherein the vibration plate is flexibly disposed on one end of the bracket via a tail sleeve.

5. The electronic device of claim 1, wherein the vibration plate is flexibly disposed on one end of the bracket via a latch structure.

6. The electronic device of claim 1, wherein the vibration plate is supported by a sponge (polyurethane), which allows the vibration plate to be flexibly disposed on the bracket.

7. The electronic device of claim 1, wherein a distance is between a position on the vibration plate where the bone-conduction microphone chip is disposed on and a mounting point, of the vibration plate, on the bracket, and the distance is at least 50% of a length of the vibration plate.

8. The electronic device of claim 1, further comprising:
a wireless communication module, coupled to the bone-conduction microphone chip and configured to wirelessly transmit the audio signals to a host device; and
a battery, coupled to the wireless communication module and the bone-conduction microphone chip and configured to provide power to the wireless communication module and the bone-conduction microphone chip.

9. The electronic device of claim 8, wherein the battery, the wireless communication module and the bone-conduction microphone chip are integratedly disposed on the electronic device.

10. The electronic device of claim 1, further comprising:
an audio jack, coupled to the bone-conduction microphone chip and configured to wire-transmit the audio signals to a host device; and
a battery, coupled to the bone-conduction microphone chip and configured to provide power to the bone-conduction microphone chip.

11. The electronic device of claim 10, wherein the bracket includes a hollow metal tube, the audio jack and the battery are disposed on the bracket, and the audio jack and the battery are coupled to the bone-conduction microphone chip disposed on the first surface of the vibration plate through a wire passing through the hollow metal tube.

12. The electronic device of claim 1, further comprising:
an audio jack, coupled to the bone-conduction microphone chip and configured to wire-transmit the audio signals to a host device and receive power from the host device for providing the power to the bone-conduction microphone chip.

13. The electronic device of claim 12, wherein the bracket includes a hollow metal tube, the audio jack is disposed on the bracket, and the audio jack is coupled to the bone-conduction microphone chip disposed on the first surface of the vibration plate via a wire passing through the hollow metal tube.

14. The electronic device of claim 1, wherein the first surface of the vibration plate faces away from the first direction, such that the bone-conduction microphone chip disposed on the first surface faces away from the first direction.

15. The electronic device of claim 1, wherein the first surface of the vibration plate faces the first direction, such that the bone-conduction microphone chip disposed on the first surface faces the first direction.

16. A method, for receiving a voice of a user, executed by the electronic device of claim 1, the method comprising the steps of:
(a) securely mounting the vibration plate on the bracket of the electronic device;
(b) positioning a surface of the vibration plate substantially perpendicular to a direction of sound emission of the voice of a user;
(c) causing the vibration plate to vibrate by a sound wave generated by the user; and
(d) detecting a vibration signal of the vibration plate and converting the vibration signal into an electronic signal representing the voice of the user.
